(19) United States
(12) Patent Application Publication
(10) Pub. No.: US 2001/0032229 A1
(43) Pub. Date: Oct. 18, 2001

(54) Method and system for conducting commercial transactions by computer network

(76) Inventors: John Hulls, Point Reyes, CA (US); Christopher R. Hulls, Point Reyes, CA (US)

Correspondence Address: John Hulls, P.O. Box 787, Point Reyes, CA, 94956, US

(21) Appl. No.: 09/733,517

(22) Filed: Dec. 7, 2000

Related U.S. Application Data
(60) Provisional application No. 60/169,833, filed on Dec. 7, 1999.

(51) Int. Cl. G06F 9/00

(52) U.S. Cl. 709/101

(57) ABSTRACT

A computer based means and system for the undertaking of three party (or more) transactions consisting of a buyer, seller and agent, or other facilitating party where not all of the parties necessarily have a presence on the Internet® or other type of network. A further aspect of the invention is the use of dedicated e-mail and/or phone systems or other communication system operating in parallel with the transactional system to prevent uncontrolled access between the parties, thus allowing transactions to occur on a first come, first serve basis rather than excessive number of calls between agents and sellers and agents and buyers. All parties to the transaction can participate in an agreed upon manner. A buyer can request that all the agents search for the seller of a specific item, or can request one agent to search for them, and a seller can do likewise. Agents may offer their services to buyers or sellers, or any combination that may suit the needs of the participants. Agents can search non-internet or non system based sources for items or buyers and provide an interpretive expert function that exceeds key word searches in support of both buyer and seller. The system also tracks the expertise of agents, so that a buyer and seller may look up an agents past performance. Access to lists of buyers, sellers, agents and information on transactions can be controlled on a fee basis. the system can also be operated in parallel with a conventional on-line auction system.

### FIELD OF INVENTION

The method and apparatus of the present invention relate to multi-party commercial transactions using electronic networks.

### BACKGROUND

All existing electronic network systems assume that transactions will be handled directly between buyers and sellers, using a variety of different protocols. Indeed, various methods have been proposed to implement Internet® transactions between two parties. However, this does not recognize that a far larger marketplace exists beyond the Internet and other networks, not does it acknowledge some basic limitations in computer networks.

This poses a wide variety of problems in optimizing commerce as businesses and individuals try and perform efficient commercial transactions on the Internet®. While the means of conducting auctions and other exchanges on the World Wide Web is well known, the problems of creating an electronic means of commerce that encompasses all of the potential buyers and sellers of a given commodity, both on and off the Internet® inhibits the development of electronic commerce.

One of the problems in using the World Wide Web or Internet® for commercial transactions is that the staggering volume of commercial information on the Internet® is too great for an individual to access, spread across a wide variety of web sites, bulletin boards, auction sites and other listings, and the items for sale/wanted on the Internet only represent a small fraction of the total market. Thus, it is exceedingly difficult for a buyer to find all the ads relevant to his wants and visa versa.

Likewise, the use of search engines and software agents does not provide access to non-Internet® listed buyers and sellers, thus ignoring the larger potential markets.

The use of search engines and software agents also limits network commerce to very specific fields where efficient searches can be conducted. A good example of this is book sales, where author, title and ISBN number can serve to identify virtually any book, or airline tickets, where time and locations can be easily specified. Other areas have been successful such as marketplaces for industrial chemicals. For other market segments, the small amount of language in most want ads causes problems for computerized evaluation, as minor changes in description of a product will cause it not to be detected by software agents or will produce a number of hits that are irrelevant to the request. This is a well known problem in computer evaluation of text and language, as is well understood in the field of artificial intelligence (AI). There is little chance that a search engine or software agent such as that discussed in U.S. Pat. No. 5,794,210 Aug. 11, 1998) could be built with AI capabilities that are both perceptual and cognitive, which would be required to search the Internet on behalf of a buyer or seller, and by definition, could not search non-network sources.

A good example of the problem would be a buyer who wants to purchase a small tractor for light work on his retirement farm apple orchard or someone who wants to purchase a used Kubota L3410 @ tractor, which is essentially asking for the same thing. A keyword search on several search engine produced thousands of non-relevant citations, or none at all, and none in response to the specific identification of the tractor, even though several were available at the local dealers in California. To serve a potential buyer, it is necessary to understand both the perceptual message, as well as the cognitive. eg. the type of tractor necessary to fulfill the requirements, and the ability to recognize the specific make and model number of a suitable tractor, and that it be listed in that manner on an accessible page on the World Wide Web.

These problems are well recognized by the industry. The May/June issue of the journal “Online”, in an article entitled “Natural Language Processing meets Jabberwocky” covers the language limitations of search engines, even when coupled with meta-search engines (those search engines that allow multiple searches) and also point out that even at the level of information retrieval, the final usefulness or practical level “depends on a body of knowledge about the world that comes from outside the contents of the document.” In the same issue, an article on search engines in the internet age makes the point that “the Information professional is best served with multiple search tools and multiple search strategies” For the individual customer searching for a specific item, this is clearly not a practical approach.

In the June 99 issue of Business 2.0, in an article entitled “New Rules” lists Rule #7.” Efficiency. The middleman lives. “Infomediaries” replace Intermediaries” It then goes on to state that no such “infomediaries” exist today. Without such intermediaries, the efficiencies of the internet market are available only in specific areas and only to individuals who are familiar with specific internet market niches or have the time and resources and motivation to perform time consuming searches.

By providing an environment where agents and intermediaries or “Infomediaries” can facilitate conducting transactions across the entire market spectrum and not just the Internet, the subject invention will significantly increase the efficiency of the marketplace.

### SUMMARY

In accordance with the present invention a computer network based transactional method which executes on a computer system and network including processor means, data storage means, registers, register formation means, display means, input means, communication means, and communication mediation means which allow interaction between multiple parties such as buyers, sellers and agents to locate each other and undertake and complete independent commercial transactions on the World Wide Web, as well as being able to encompass parties who are not connected to the Web.

### Object of the Invention

It is the purpose of the invention to provide a network system operating in conjunction with a communications system whereby a marketplace is created in which buyers and sellers and agents may undertake transactions mediated by the interactions of the network and the communications system.

It is also a purpose of the invention to allow such transactions to take place with one or more of the parties not being located on the network.

It is also the purpose of an invention that the communications between the parties take place by means of a designated communications system such that the communications can be mediated by the network. Note that e-mail and phone access can be either stand alone systems or incorporated in the network hardware and software.

It is also a purpose of the invention to provide a series of registers of buyers, sellers, agents, sales, classifications and other such registers as may facilitate transactions that may be accessed by members of the network in a controlled manner also mediated by the interaction of the network and the communications system, including parties not located on the network.

It is also a purpose of the invention to track communications concerning a transaction and apply regulatory code numbers to the communications network such that the network can be made to regulate contacts between the parties based on a hierarchical series of steps and instructions.

It is also a purpose of the invention to regulate communications between agents and buyer/sellers such that parties can control the number of calls they receive on a given transaction and prevent overloading individual transaction participants with excessive numbers of communications.

It is a further purpose of the invention that participants in the transaction be allowed to select the methods and hierarchy by which other parties to the transaction respond to transactions. e.g name, price, time, duration of offer, number of responses etc. (this is as contrasted with an auction where one set of rules applies to all respondents to a transaction.)

It is a further purpose of the invention to permit buyers and sellers and agents to structure their own form of transaction and have a log maintained by the network, and do so in conjunction with a selection of encryption means with digital signatures, network escrow and other e-trade type services.

### BRIEF DESCRIPTION OF THE DRAWINGS:

FIG. 1 is a schematic of the system.

FIG. 2 is the screen image of the “home page” of the system as presented to a user.

FIGS. 3-30 are display screens presented to a user and demonstrate the operational logic of the invention

### PREFERRED EMBODIMENT

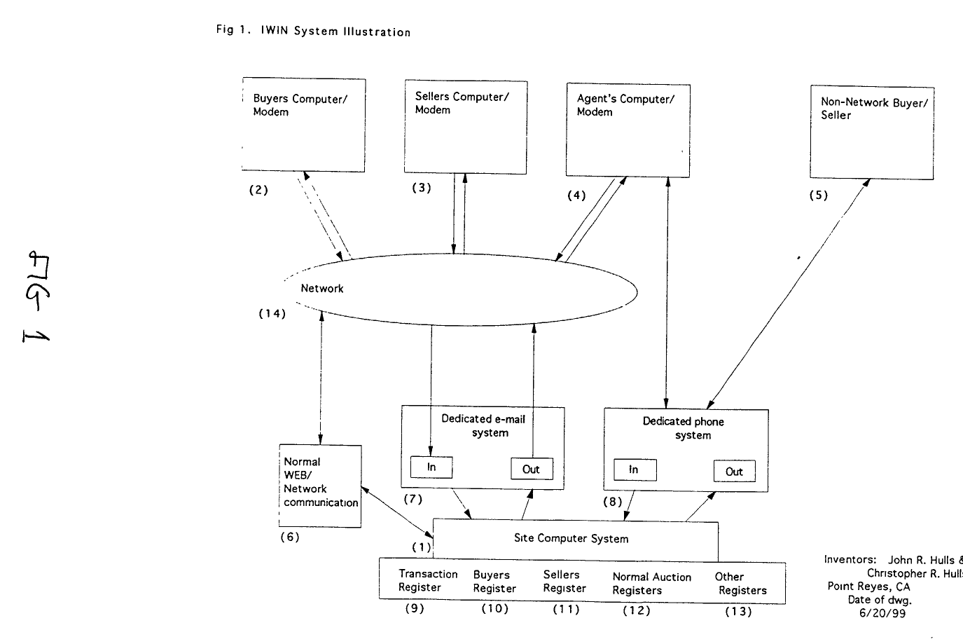

In the preferred embodiment, as shown in FIG. 1., the system comprises the site computer (1) which is connected by to the buyers computer/modem (2), the sellers computer/modem (3), the agents computer modem (4) and the non/network buyer/seller(5). The communications between the site computer(1) the network (14) and the other parties is by means of normal Internet type or web communications (6), a dedicated e-mail system (7) and a dedicated phone system (8) The e-mail system and phone system functions can also be either hardware or software based.

Any party (2,3,4) on the network(14) can contact the site computer and learn about the site through a normal web page, and can also register with the site by typical site “membership” registration as is typical with, many internet web sites. The non-network buyer/seller can contact the site through a dedicated phone system (8) that could be a menu type phone server or direct Voice connection. It is envisioned that man; of the contacts between non-network parties will be instigated by agents looking for items to fulfill buyers requests.

Once a party is registered with the site computer, all of the communications between the parties are modulated by the dedicated communications system (7,8) When a buyer or seller requests a transaction, the site computer places the information in the transaction register (9) which lists details of the transaction and may be accessed by the parties to the transaction. The register can also contain information from the buyer or seller or agent as to what conditions they wish to place on the transaction, such as number of responses they wish to receive, price range limitations and other terms. The register also provides the capabilities to archive a copy of an agreement between buyers and sellers and agents and send the parties to the transaction confirmation copies by electronic means such as e-mail or fax. In this manner, the various parties to the transaction can use the system to structure and record virtually any form of sales transaction.

A unique feature of the dedicated communications systems operating in conjunction with the site computer and the registers that it contains is the ability to control and register all communications between the parties. For instance, to prevent a large number of agents looking to fulfill a buyer's request from contacting the same seller and becoming a nuisance, the first agent to call a seller (on or off the net, through either the dedicated e-mail or phone system) would be assigned a transaction code and could continue to contact the seller. Another agent attempting to call the same seller at a later time would be blocked from calling a number or address that had already been called, as the site computer system would check the register and only allow the agent with the transaction code to contact that particular seller. This is only one of a large number of ways in which the site computer, operating in conjunction with the registers and controlling the communications systems can mediate transactions.

The features of the system can be demonstrated by way of an example as shown in a review of the screen shots of a program that represents the capabilities of the system . The system can be used on virtually any computer platform, and in the example shown in the screen shots, is a html type stack program. The system could be configured on many data base programs, object oriented programs and computer switched communications systems. The examples are illustrative of the basic functionality of the system and are in no way intended to limit the flexibility of the system to suit different markets etc.

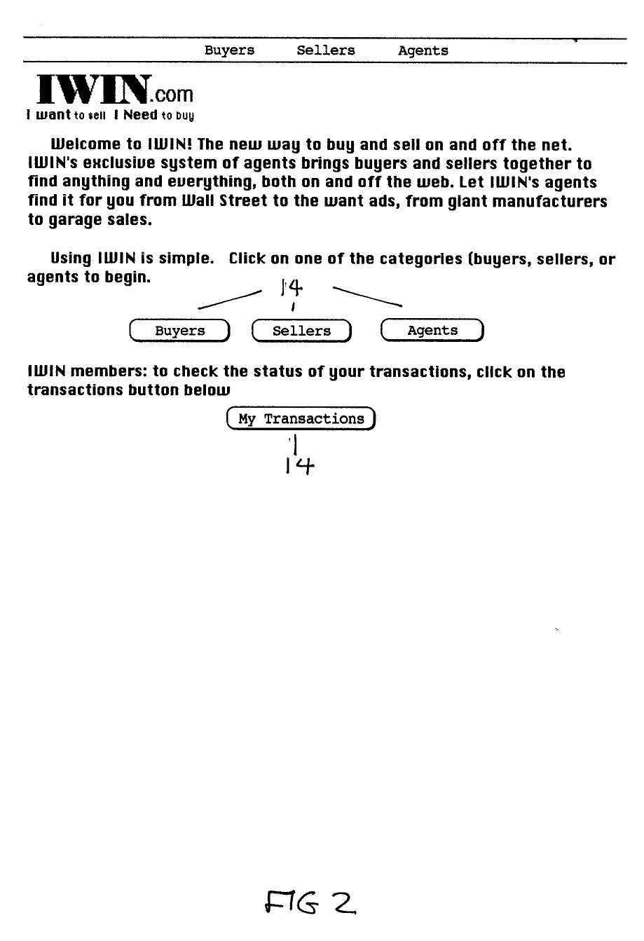

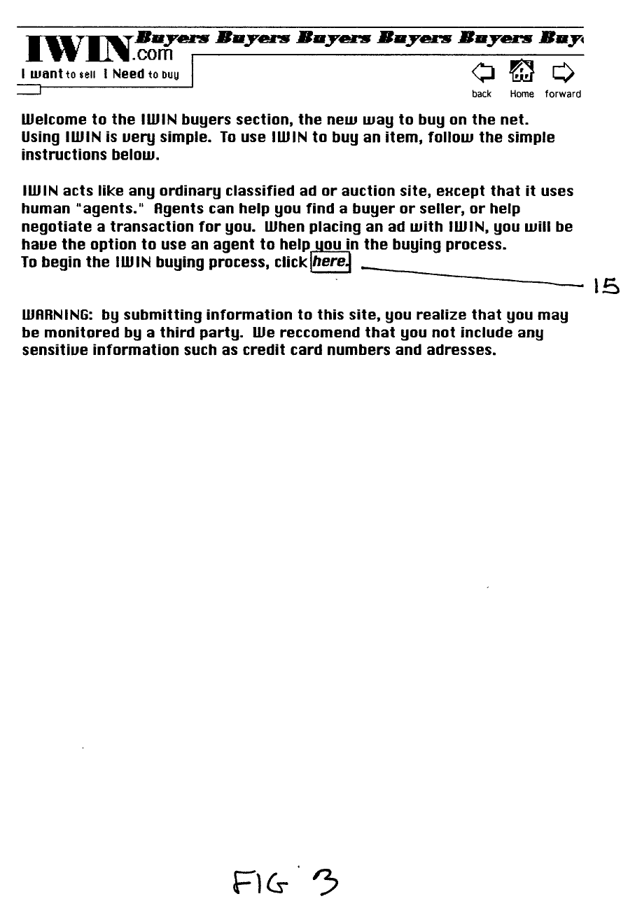

### FIG. 2

The categories for buyer, seller, agent, and transactions are represented to show how the parties access the screen.

### Example of Buyers portion of program

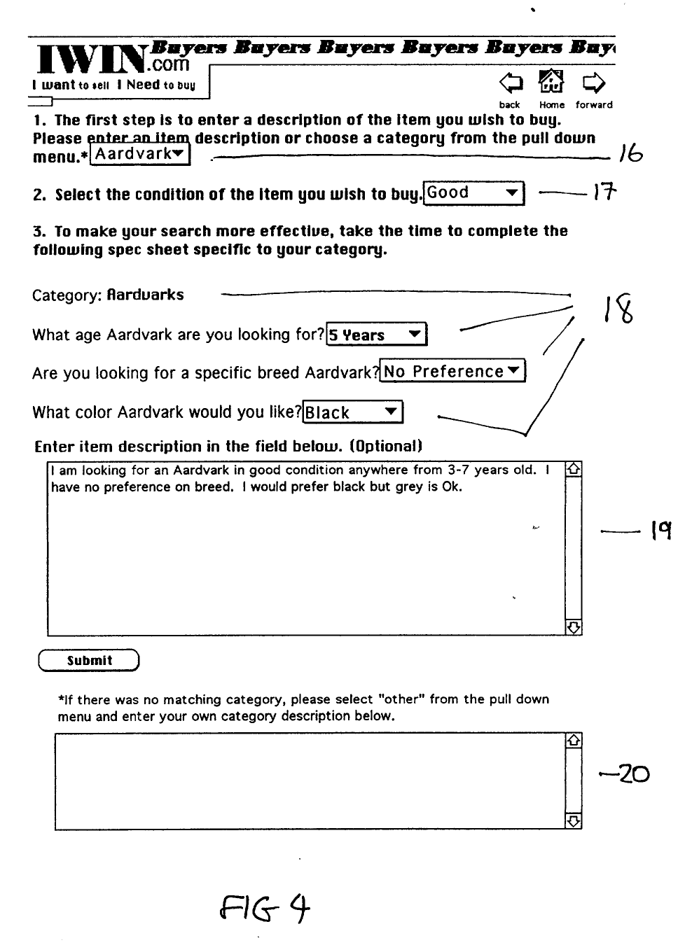

### FIG. 3

Upon selecting the “buyers” button as shown in FIG. 2, the user is shown a screen as in FIG. 3. The “buyer” process is described and the user is directed to click button 15.

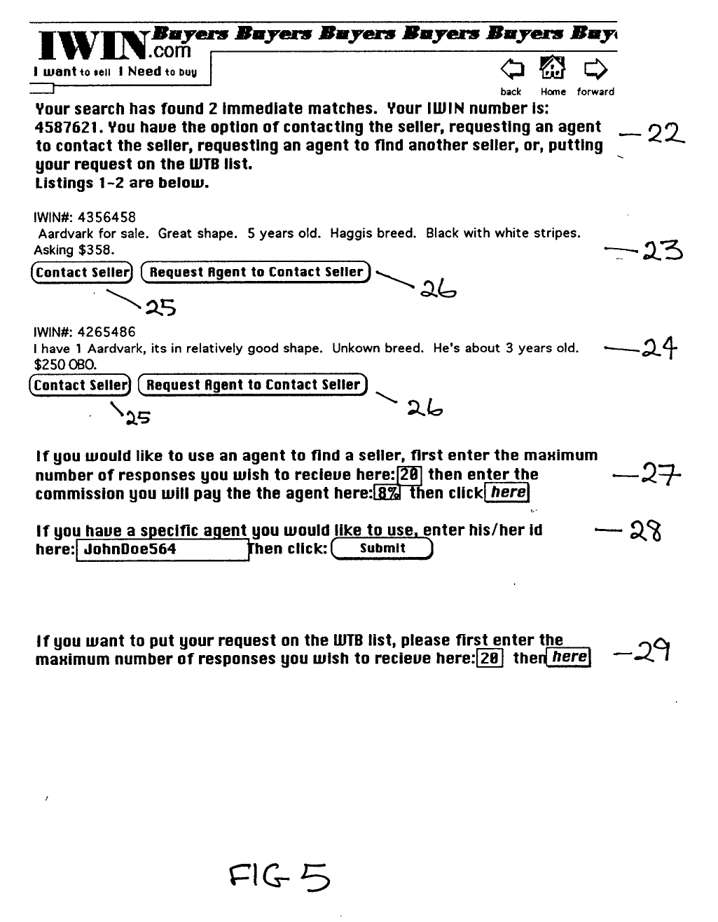

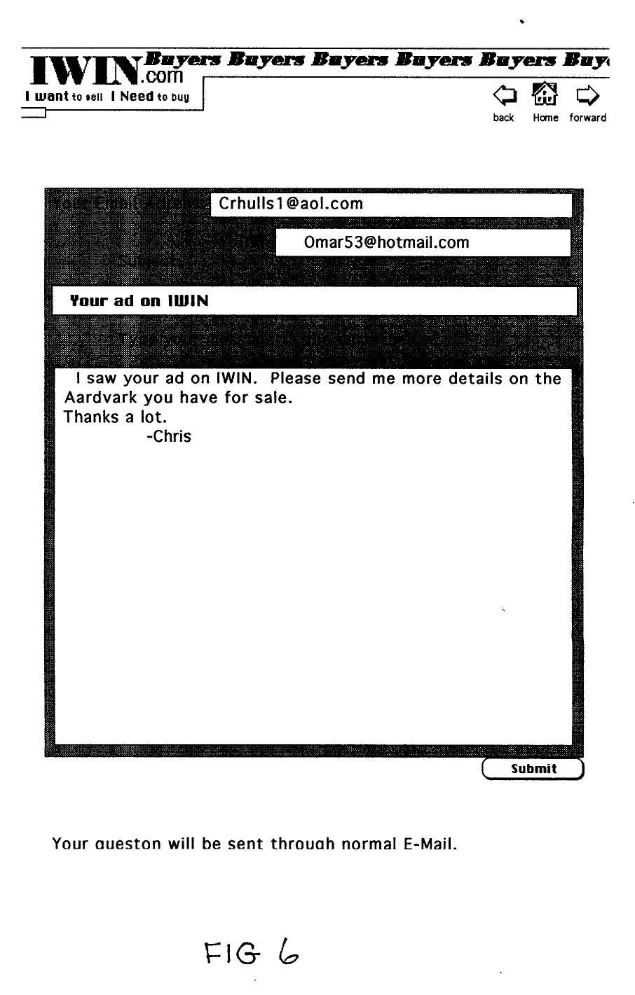

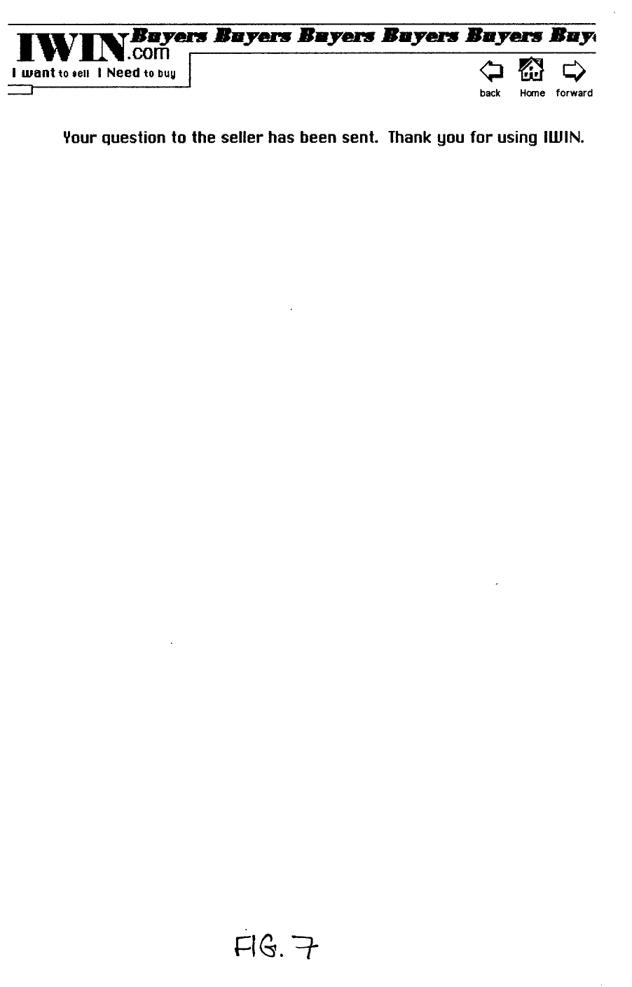

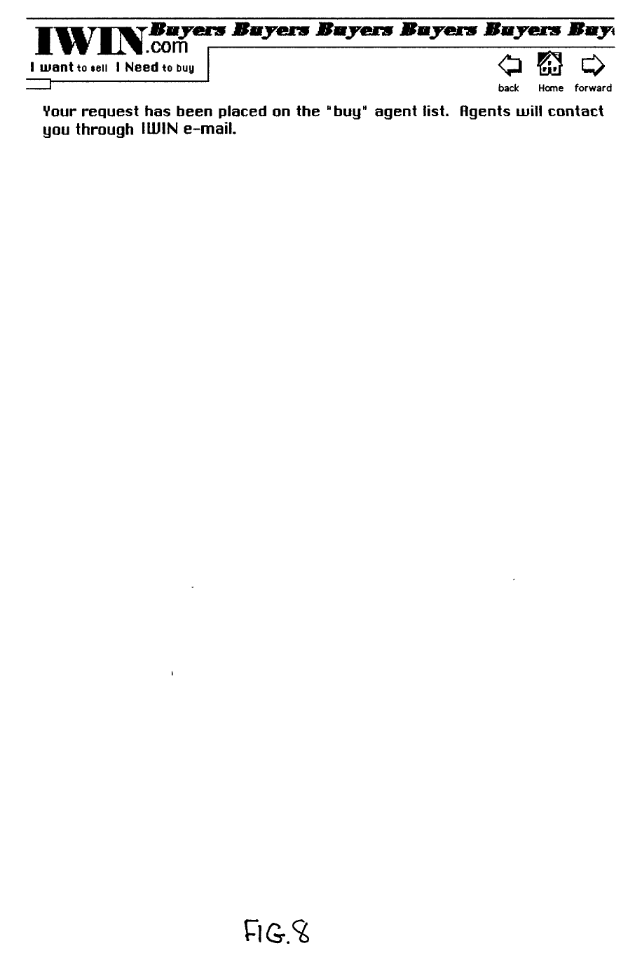

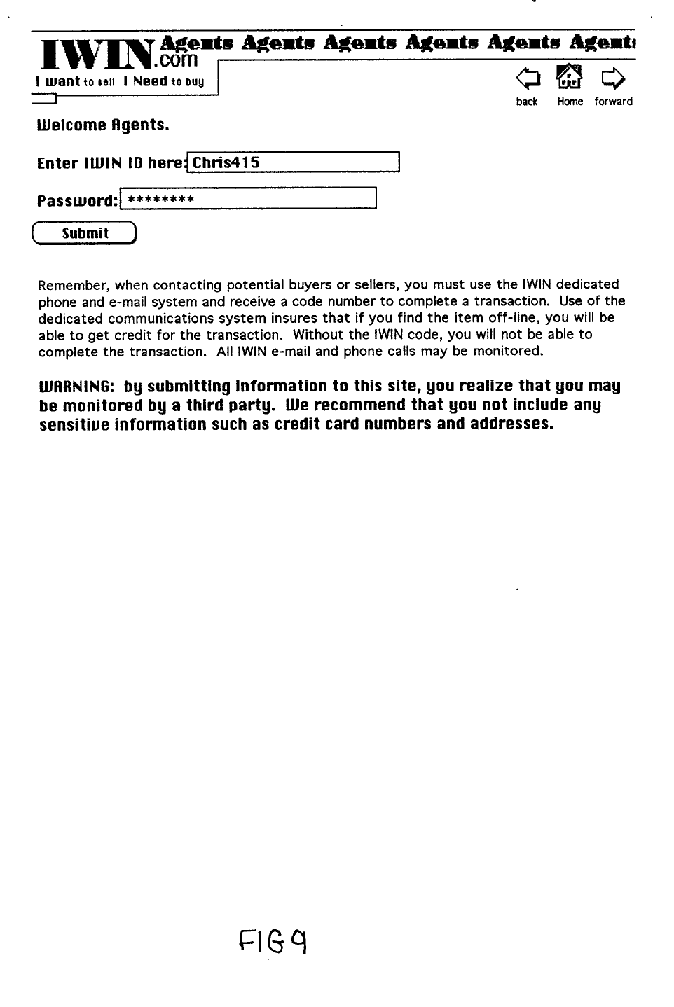

### FIG. 4

The User is showed the screen shot in FIG. 4 and asked to make a selection from the “categories” menu (16). Note that this register of categories could cover a wide range of items and may be accesed by “pull down” type menus, search engines, or a variety of means. Upon clicking button 16, and selecting a category, entering item condition by through button 17, the computer will search the appropriate registry to see if a specification sheet is available—if a specification sheet is available in the registry, it will be displayed by pull down menus (18). An optional description field (19) is shown where sellers may further describe the item. If there is no spec sheet item 18 will show a field so indicating and prompt the buyer to fill out field 20. The user is then prompted to push the submit button (21).

### FIG. 5

The computer searches the register for want ads [FIG. 1 (12)] and reports any matches as displayed in the fields 22, 23, and 24. Fields 23 and 24 are examples of typical listings. They contain buttons 25 and 26 that give the option of contacting the seller, or having an agent contact the seller. Field 27 gives the buyer the option of limiting the number of responses received and also lets the buyer specify a commission that they are willing to pay. Field 28 gives the buyer the option of selecting a specific agent to find a seller. Field 29 gives the buyer the option of listing their request on the want to buy register, and also gives the buyer the option of limiting the number of responses [FIG. 1 (11)]. Note that fields 27 and 28 enable an agent to search on and off the web for a seller [FIG. 1 (5)]. Mote that in field 22 an IWIN transaction number is assigned.

### FIGS. 6 & 7

FIG. 6 is a typical dedicated e-mail system communication which is activated when buttons [FIG. 5 (25)] are clicked−The buyer may then type any message as per conventional e-mail. The transmission of the e-mail is recorded in the transaction register along with the transaction numbers from relevant parties—See [FIG. 1 (9)]. The buyer is then sent a confirmation from the e-mail system [FIG. 1 (7)].

### FIG. 8

FIG. 8 shows the screen produced if the user selects field 27 from FIG. 5. FIG. 8 is a confirmation that the request has been placed on the agent list.

### Example of Sellers Portion of Program

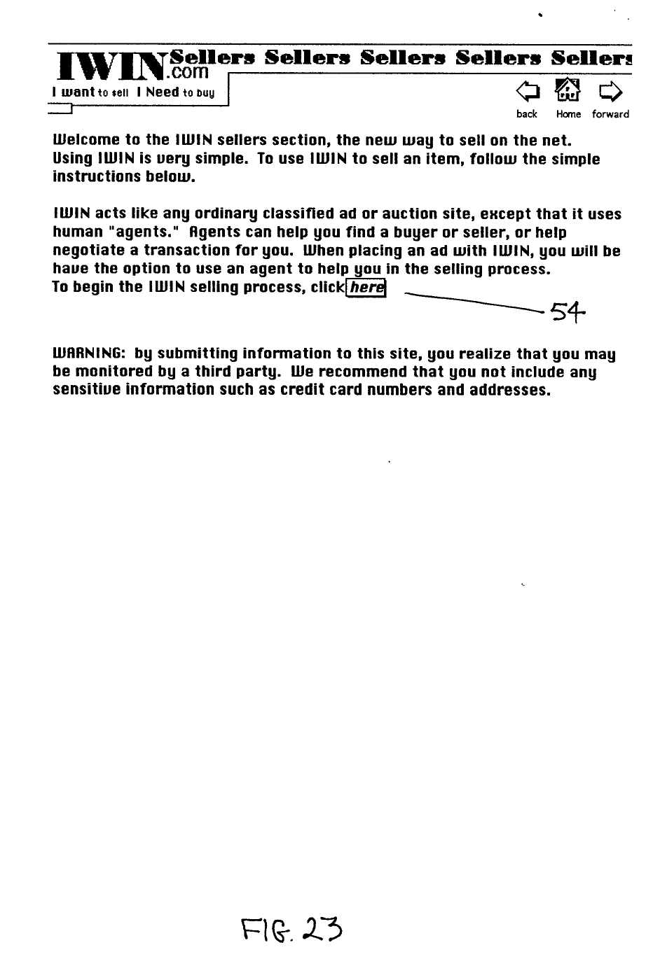

### FIG. 23

Upon selecting the “sellers” button as shown in FIG. 2, the user is shown a screen as in FIG. 23. The “seller” process is described and the user is directed to click button 54.

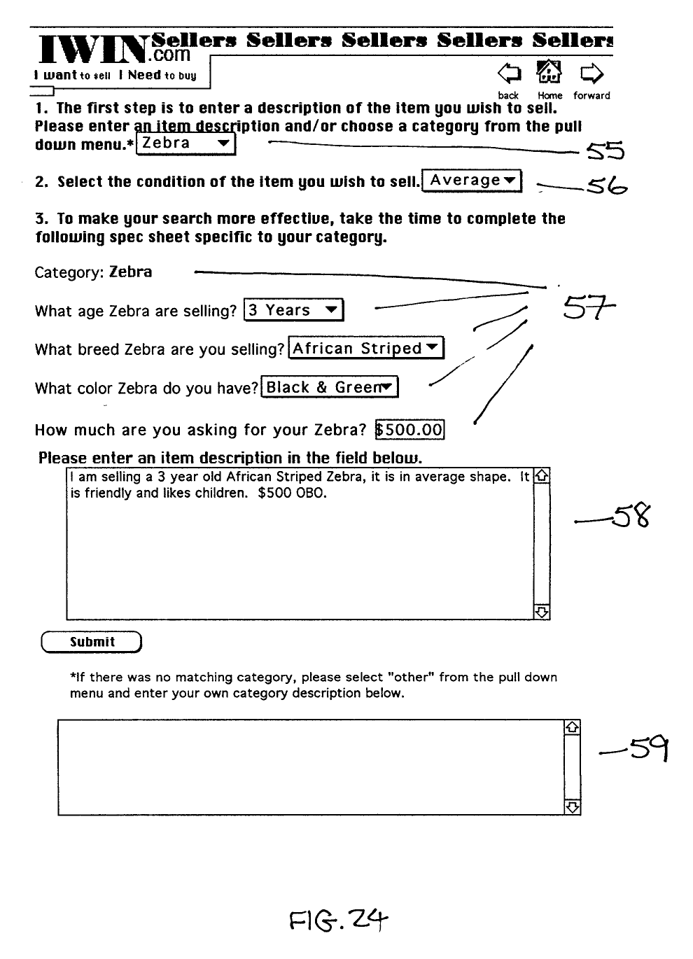

### FIG. 24

The User is showed the screen shot in FIG. 24 and asked to make a selection from the “categories” menu (55). Note that this register of categories could cover a wide range of items and may be accessed by “pull down” type menus, search engines, or a variety of means. For instance, the pull down menu may be a list of services provided by the site, or a list of items related to a specific field, such a landscape architecture supplies such as paving, benches, outdoor lighting etc. It could also be a searchable list of manufactured items such as listed in the Thomas Register (reg tradue mark) which is an encyclopedic listing of virtually all manufactured products in the U.S. Upon clicking button 55, and selecting a category, entering item condition by through button 56, the computer will search the appropriate registry to see if a specification sheet is available—if a specification sheet is available in the registry, it will be displayed by pull down menus (57). An optional description field (58) is shown where sellers may further describe the item. If there is no spec sheet item 57 will show a field so indicating and prompt the seller to fill out field 59. The user is then prompted to push the submit button (60).

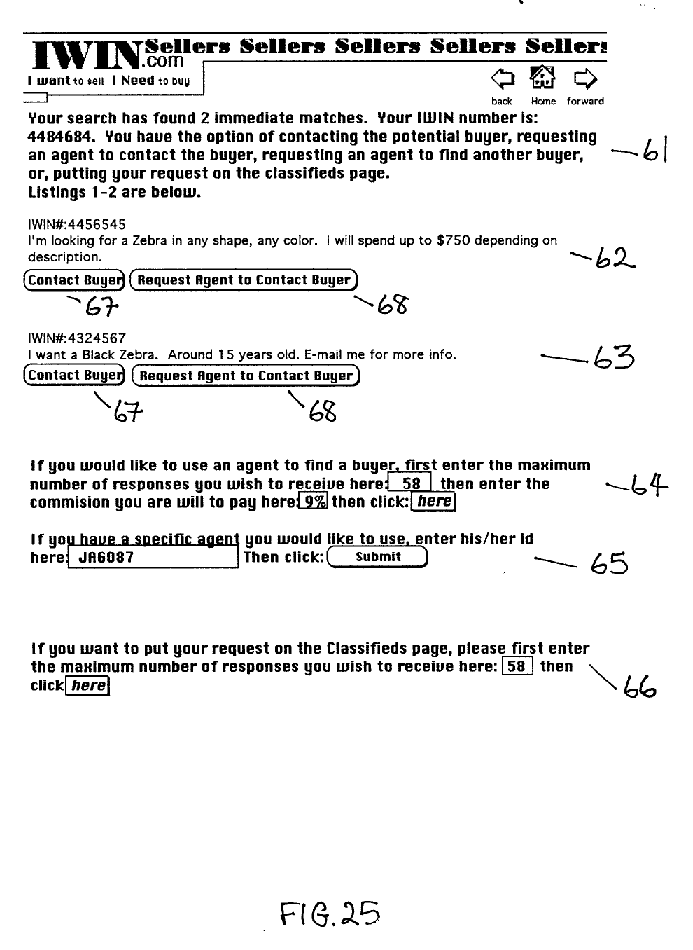

### FIG. 25

The computer searches the register for want ads [FIG. 1 (12)] and reports any matches as displayed in the fields 61, 62, and 63. Fields 62 and 63 are examples of typical want ads. They contain buttons 67 and 68 that give the option of contacting the potential buyer, or having an agent contact the potential buyer. Field 64 gives the seller the option of limiting the number of responses received. Field 65 gives the seller the option of selecting a specific agent to find a buyer. Field 66 gives the seller the option of listing their request on the for sale register, and also gives the seller the option of limiting the number of responses [FIG. (10)]. Note that field 65 enables an agent to search on and off the web for a buyer [FIG. 1 (5)]. Note that in field 64 an IWIN transaction number is assigned.

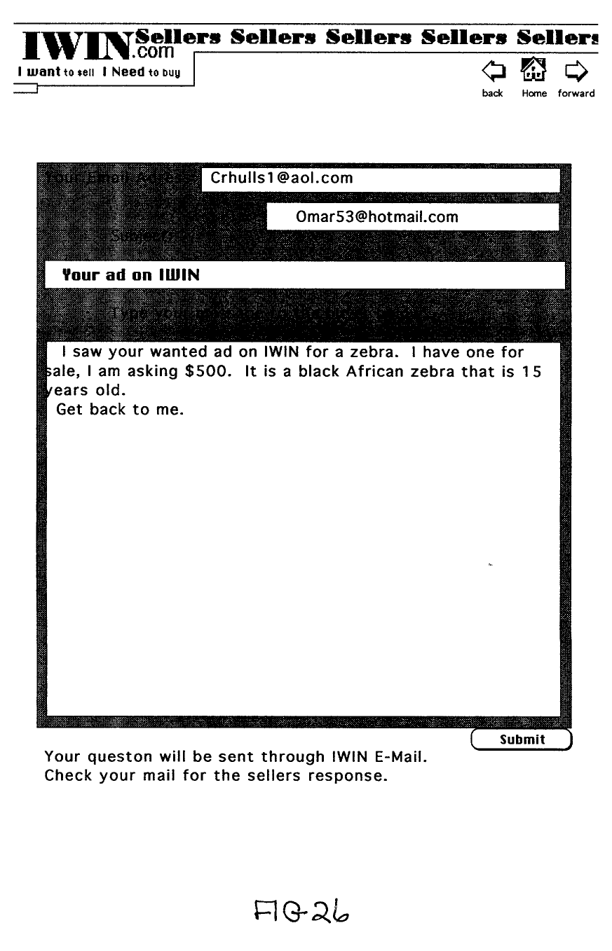

### FIG. 26

FIG. 26 is a typical dedicated e-mail system communication which is activated when buttons [FIG. 25 (67)] are clicked- The seller may then type any message as per conventional e-mail. The transmission of the e-mail is recorded in the transaction register along with the transaction numbers from relevant parties—See [FIG. 1 (9)]. The seller is then sent a confirmation from the e-mail system [FIG. 1 (7)]

### Example of Agent's Portion of the Program

### FIG. 9.

When the user click on the “Agents” button as shown on the screen shot in FIG. 1, the screen shot of FIG. 9 is shown. For the user to progress beyond this screen will require that they have a registration ID number. Control of access to web pages and programs can be accomplished by a number of means and programs familiar to those skilled in the art.

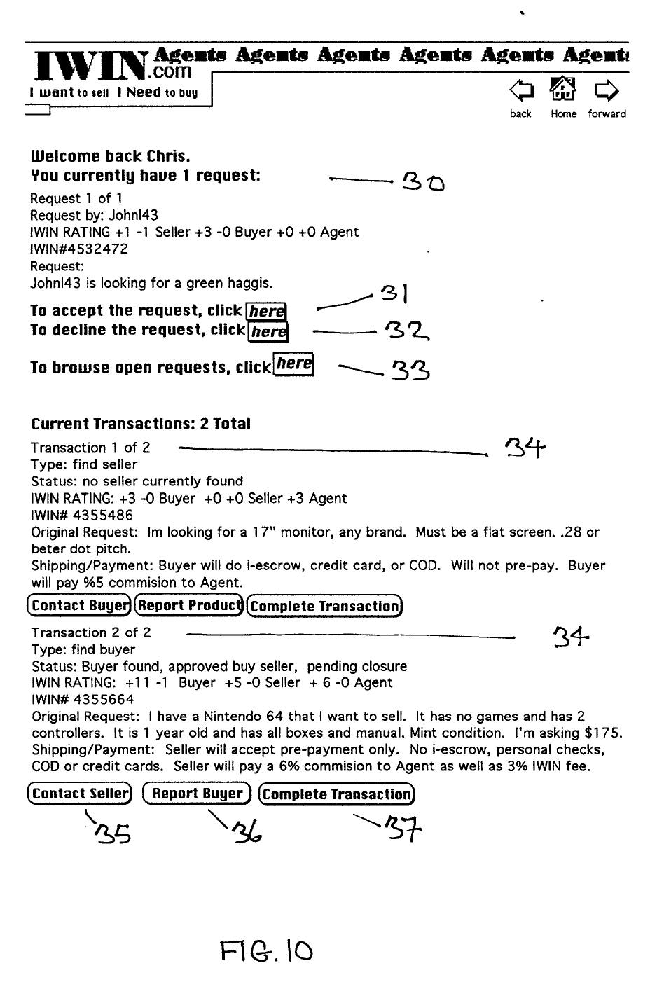

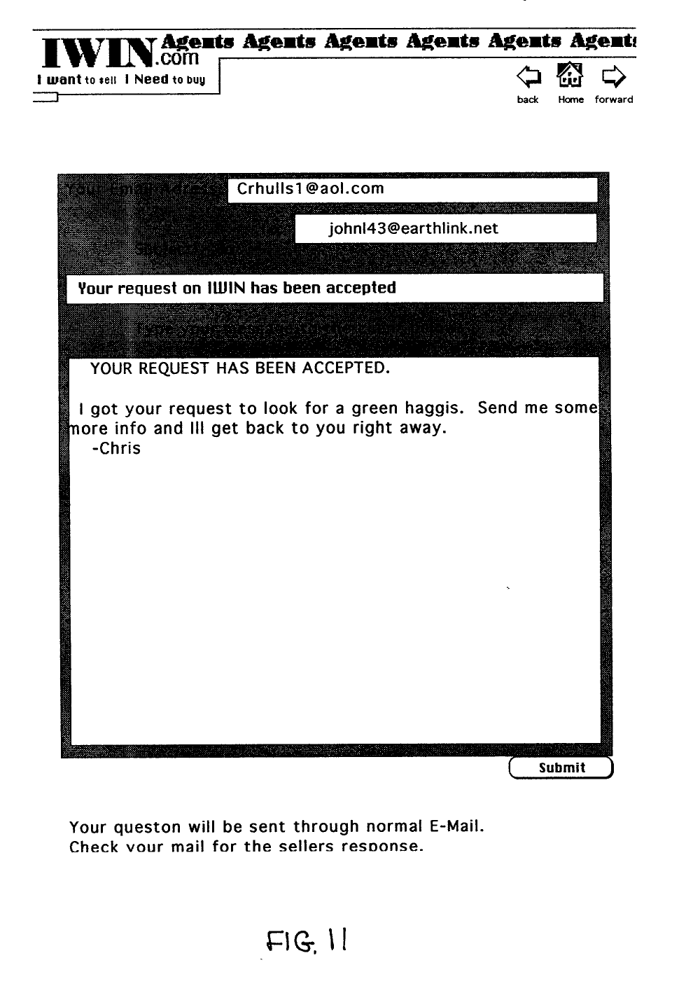

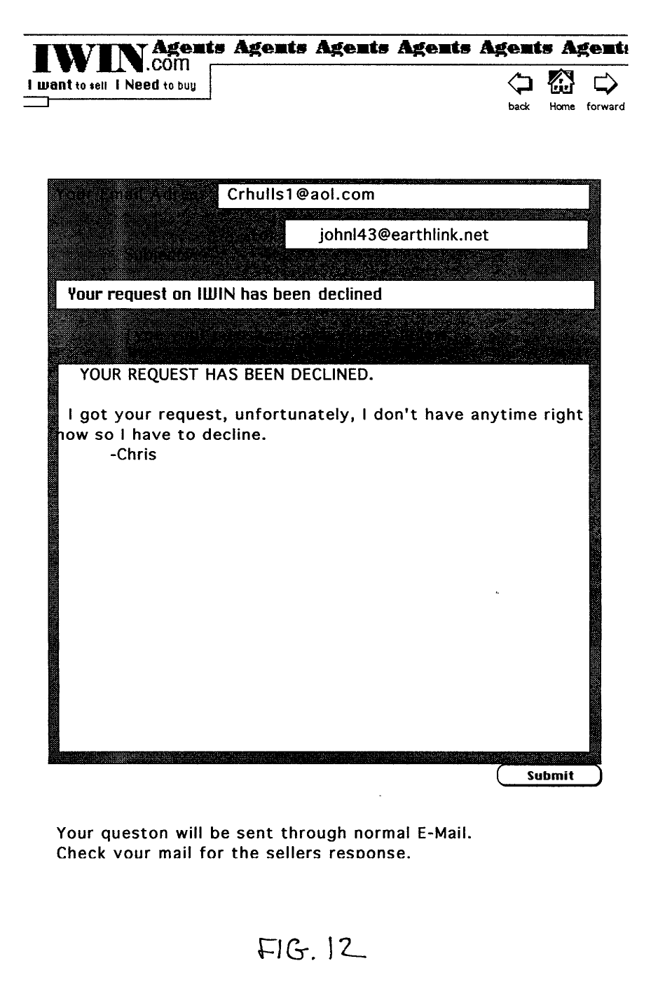

### FIG. 10

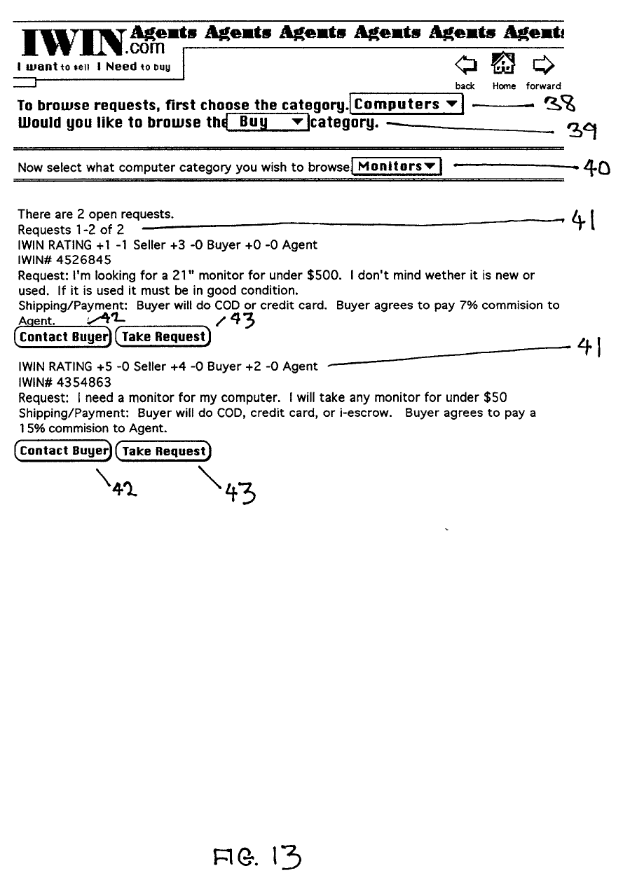

When the user completes the screen in FIG. 9, they are shown the screen shot of FIG. 10. The computer wills search the registers and reports request and current transactions on which the agent (user) is working as shown in the fields 30 & 34 respectively. The agent may then respond to requests by clicking on the button 31 to accept and will be forwarded to the screen shot as shown in FIG. 1. Clicking the button to decline the request 32, will transfer the agent to the screen shown in FIG. 12.

If the user wishes to see the open requests, he will click button 33 and be lead to the screen as shown in FIG. 13. To browse the requests, the user is directed to first choose a category from a pull down menu. 38 This menu of categories is the same as is accessible to the buyers and sellers screens and can be adapated to reflect the particular needs of each application.

The user is then directed to select if he wishes to see the buy or sell register by selecting from the buy/sell menu by so indicating on selection sub menu pull down 40.

The open requests will be displayed in the fields 41. The agent is given the option on each request of selecting either to contact the buyer for include a rating system for the various parties, based on completed transactions reported to the site.

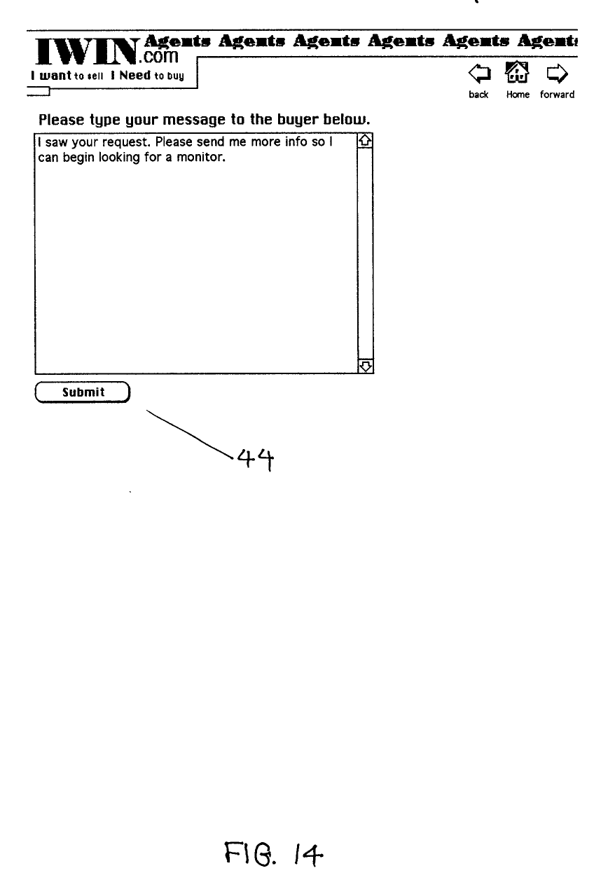

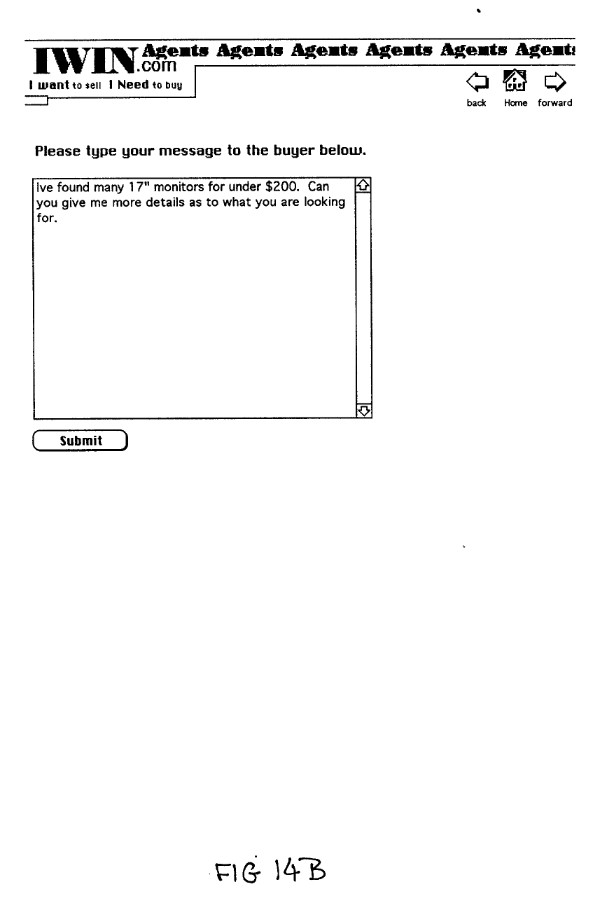

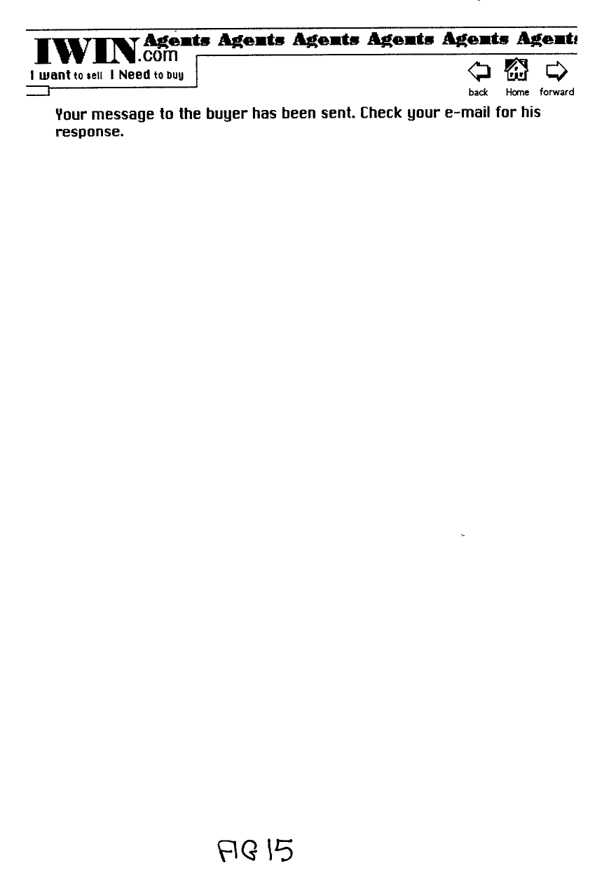

By clicking button 42 to contact the buyer, the user will be lead to an IWIN e-mail screen such as shown in FIG. 14. Upon completing the message, the user clicks button 44 to send the message to the buyer. The sending of the message will be confirmed by a screen as shown in FIG. 15.

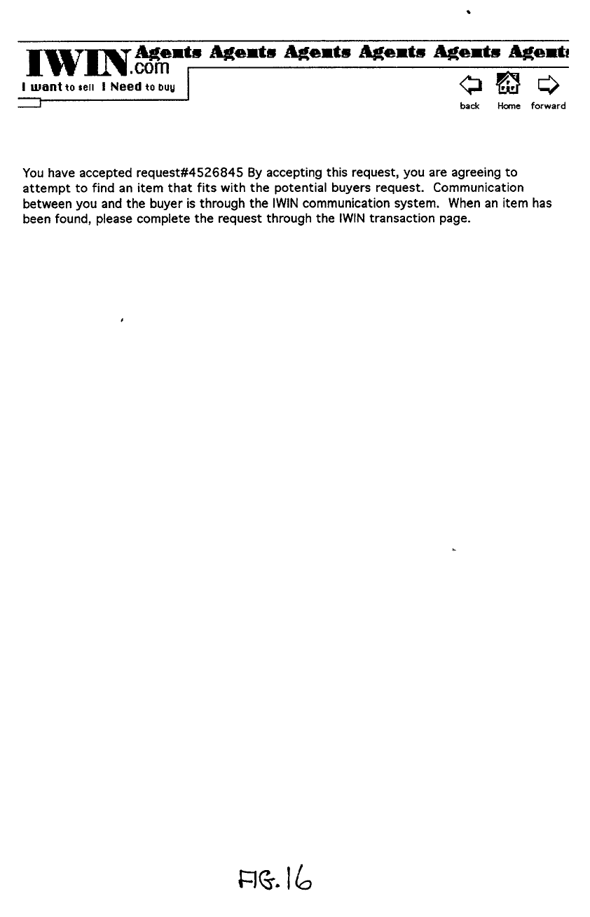

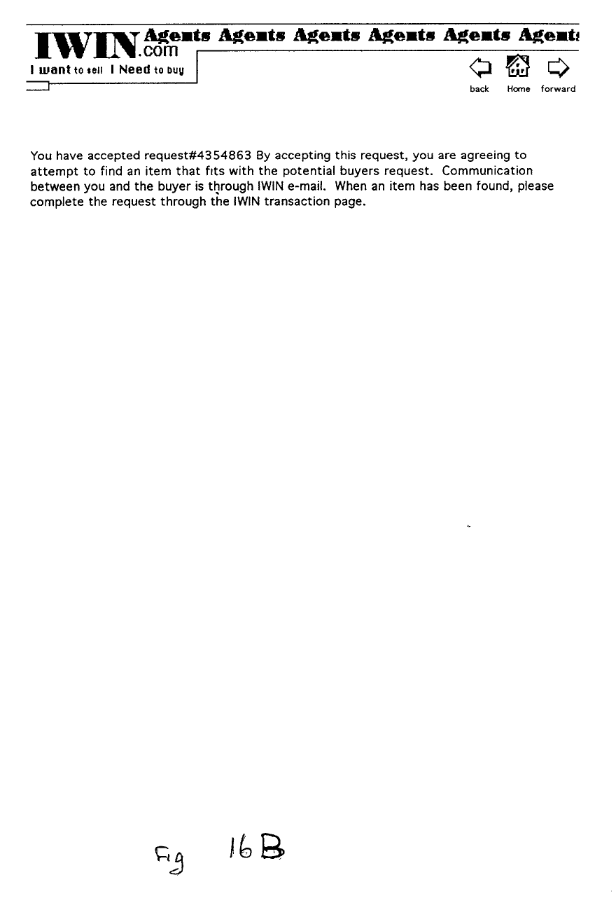

Referring again to FIG. 13, if the user wishes to take (accept the request) by clicking button 43, they will be directed to a screen as shown in FIG. 16, which assigns a number for further identification on the transaction page. Note that in the course of the transaction, the buyer and seller and agent will each be assigned a separate number specific to the transaction by which they can access the transaction register. The contact information between the parties is only by the transaction register until the transaction is complete, at which time the information such as addresses and shipping information can be presented to the buyer and seller to physically complete the transaction.

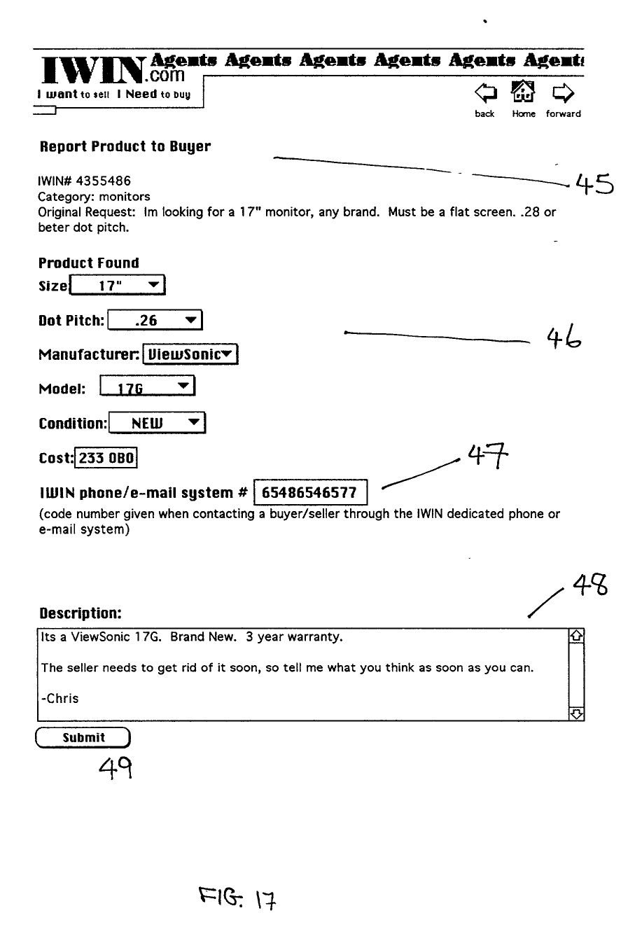

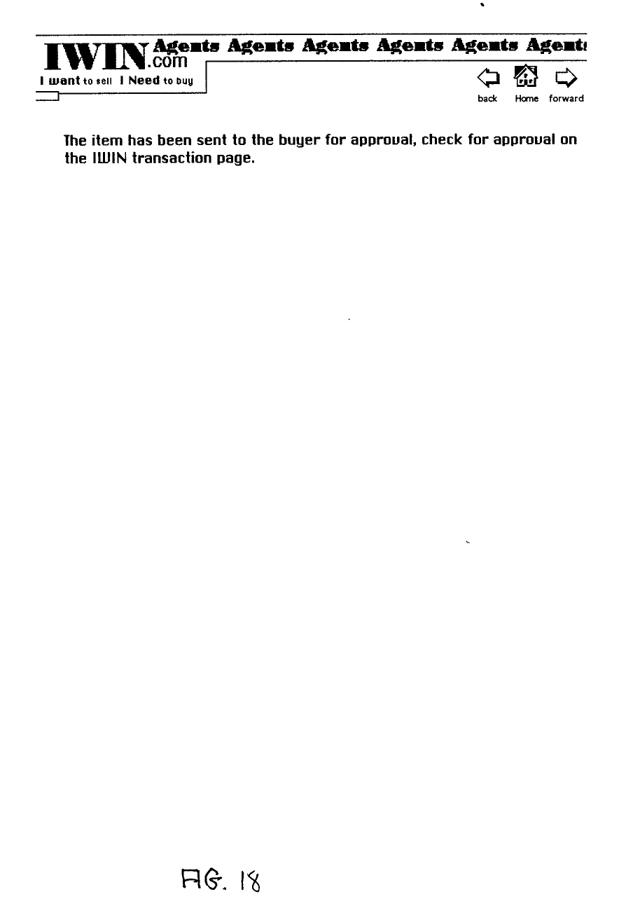

Referring back to FIG. 10, when the user has found an item and wishes to report it to the buyer, he will click button 36 in the field to which he wishes to respond, and will be directed to a screen as shown in FIG. 17. The screen will show the original request to which they are responding in field 45 The description of the product will be entered in field 46. The seller located by the agent Is assigned a specific number in field 47. The user may provide a further description in item 48 and then is directed to submit the completed report to the buyer by clicking button 49. A confirmation screen shows that the information has been transmitted as shown in FIG. 18.

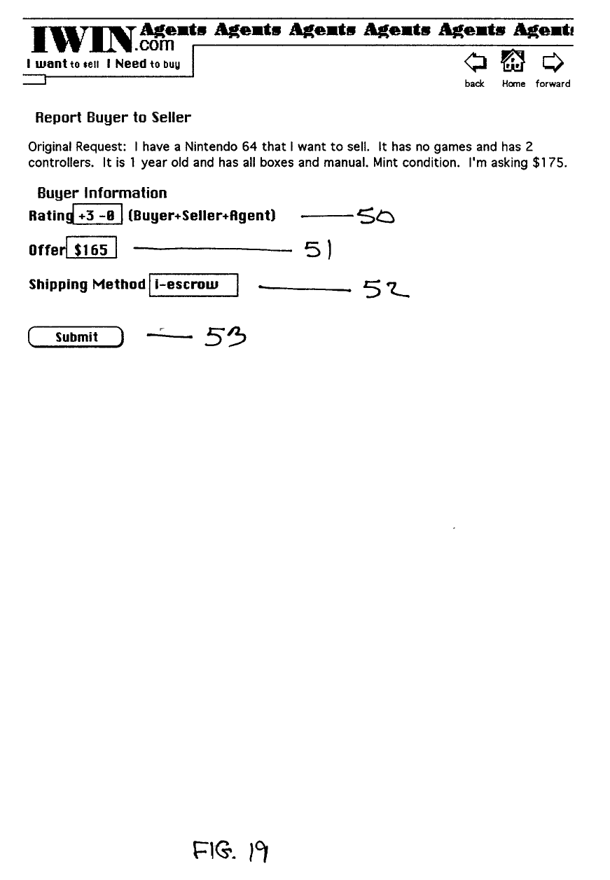

Upon acceptance or rejection of the offer by the buyer, the agent will be notified through the dedicated communication system of the acceptance. The communication (not shown)will direct the user to report the buyer to the seller as shown in FIG. 19. Once again the screen can show a rating for the buyer, seller and agent based on his transactions on the site as shown in window 50. The user (agent) lists the offer in window 51. Window 52 is an example of one of many ways in which a transaction can be completed on line and is not exhaustive. The list could include virtually any manner of commercial transaction and shipping, such as Fed Ex and UPS or could include bank letter of credit instructions, depending on the specific market in which the IWIN program is being used.

When the screen is completed, the user is directed to submit the information to the seller by clicking button 53.

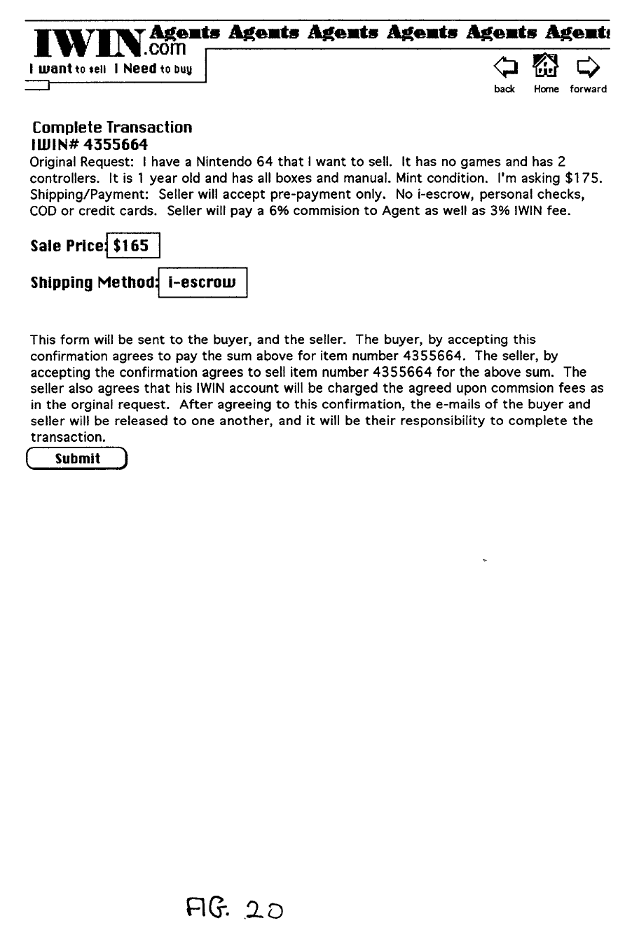

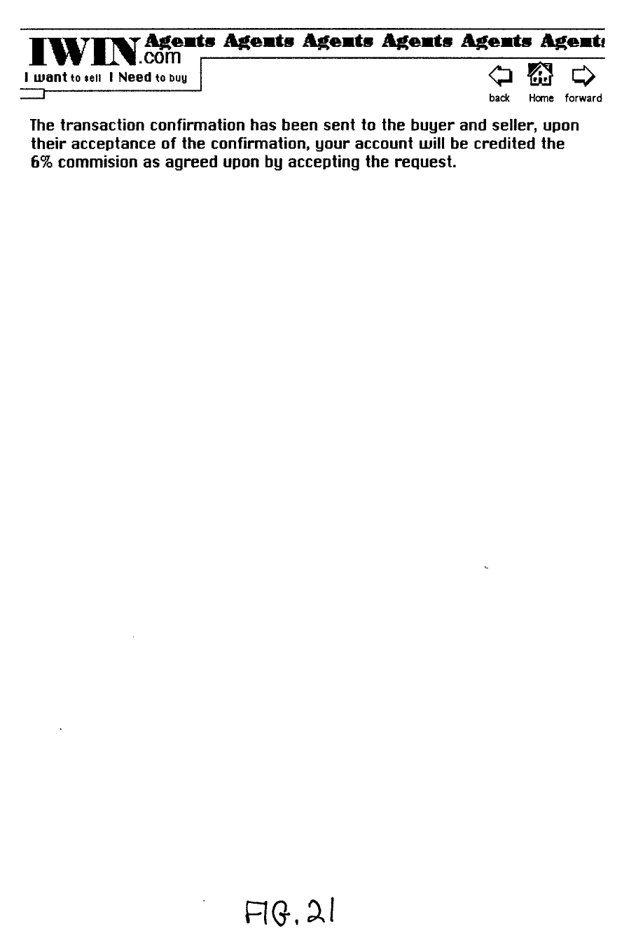

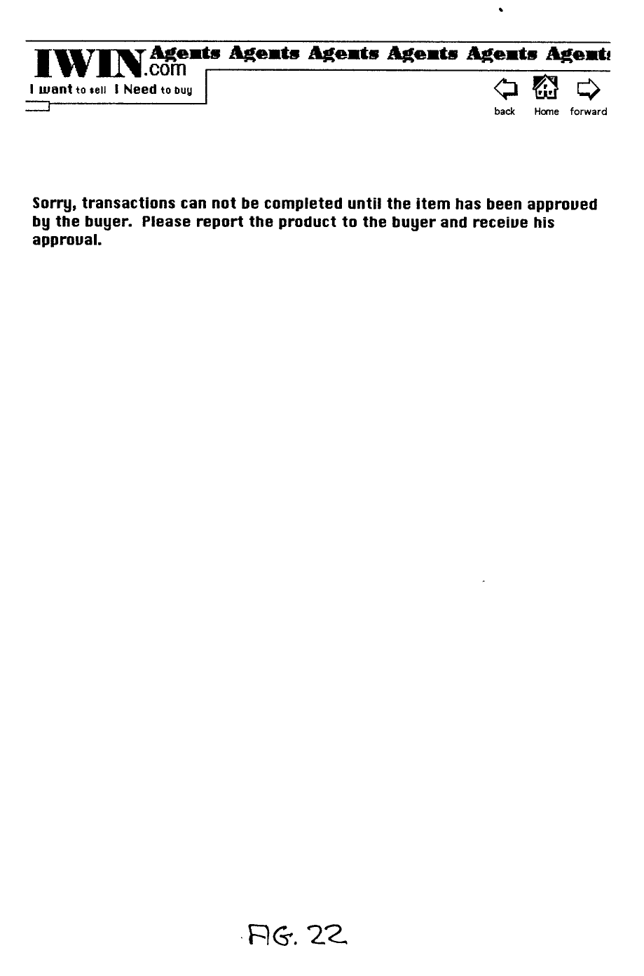

Upon the user (agent) receiving notification from buyer and seller that the transaction has been approved by both parties, which the program will log on the transaction register, the user will then select button 37 on FIG. 10 to complete the transaction, and will be shown the screen of FIG. 20, which will display all the relevant information from the previous forms. If the transaction is not complete, the screen of FIG. 22 will be shown, displaying information as to why the transaction is not complete. After reviewing the transaction, the agent will press the submit button 54, and the transaction will be completed by the buyer and seller. Transmission will be confirmed as by a screen as shown in FIG. 21.

### Example of Transaction Portion of the Program

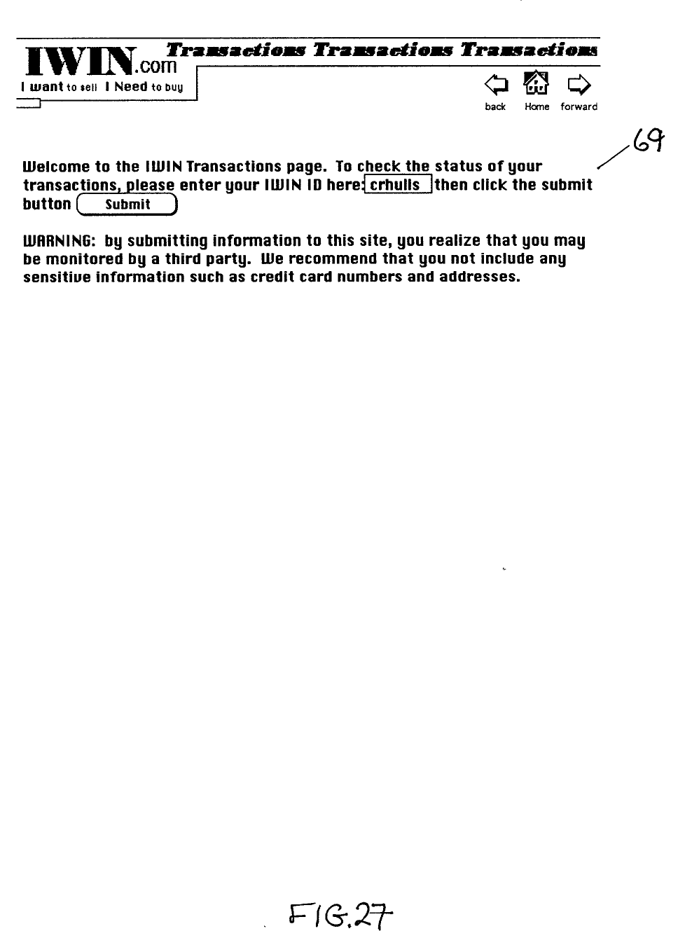

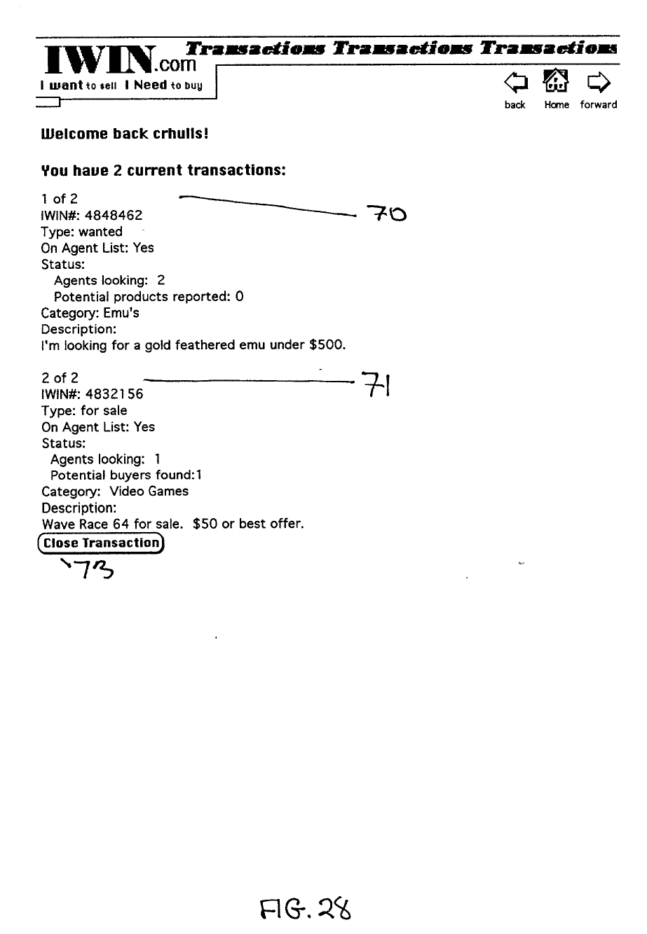

Upon selecting “my transactions” [FIG. 2 (14)], the user is brought to the transactions page (FIG. 27). The user is then prompted to enter his IWIN ID and click the submit button to proceed to view his current transactions (69).

Upon clicking button 69, the user is brought to current transactions page (28) which shows his current open transactions (70+71). If the user wishes to close a transaction, he may do so if a product or buyer has been submitted by the agent. To close a transaction, the user is directed to the “close transaction” button (73).

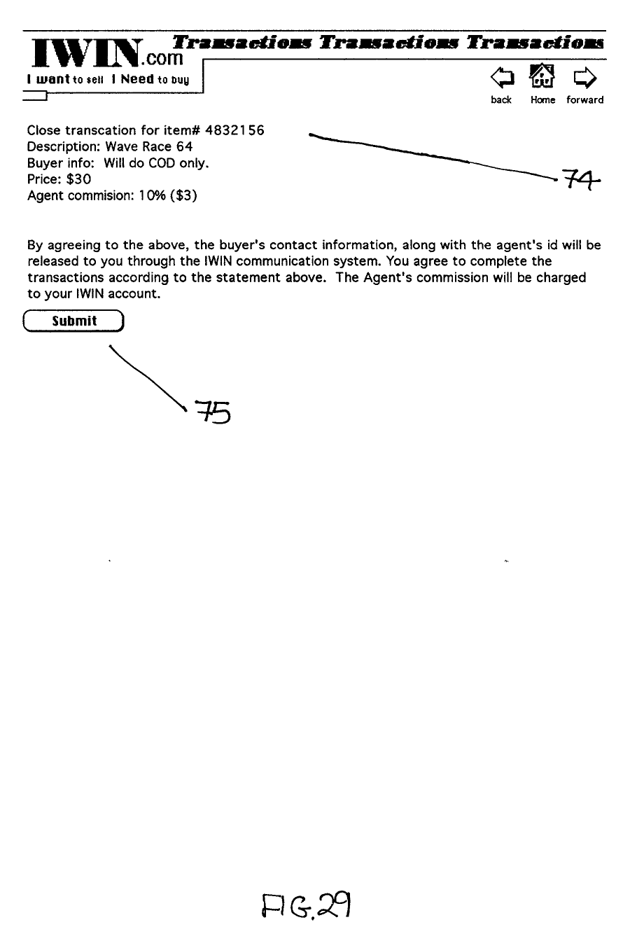

Upon clicking the “close transaction” button (73) the user is brought to the close transaction page (FIG. 29). The user is then given the guidelines and details of of the transaction (74) which he can agree to by clicking the “submit” button (75).

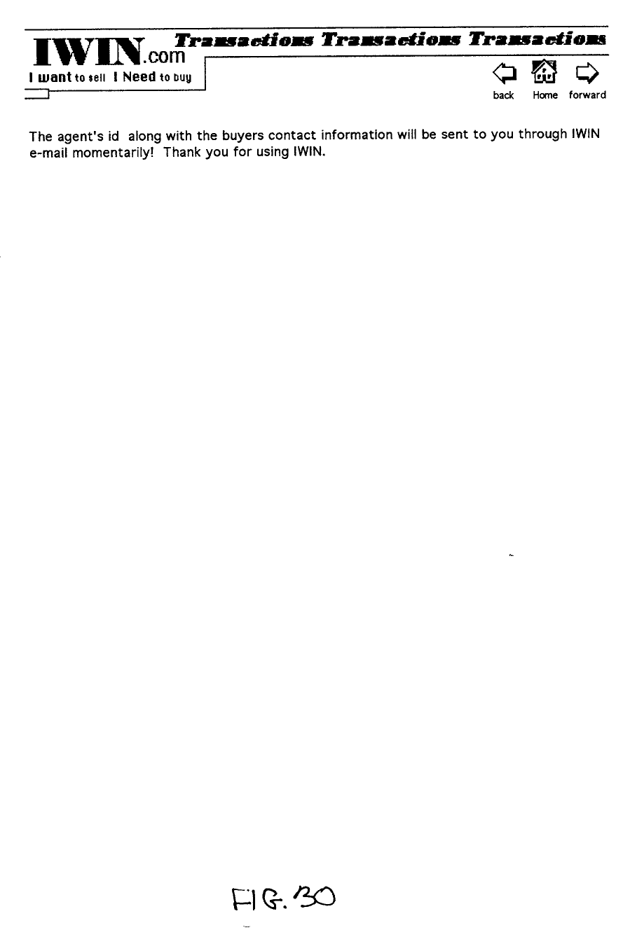

Upon agreeing to the guidelines [FIG. 29 (74)] and clicking the submit button (75), the user is brought to the confirmation page (FIG. 30) where he receives a confirmation that the transaction is now closed (76).

### Conclusions and Scope

From the description above, it will be seen that the invention provides far more of the aspects of a true marketplace than other Web transactional methods, such as site specific auction or single commodity marketplace. It is not restricted to the sale of an item, but allows the purchase of information. Thus, an agent with expertise in a given category of trade can be rewarded not only for linking a buyer and seller, but can be contacted by buyers and sellers who wish to avail themselves of his market expertise, thus further justifying his maintaining a Web presence. The invention also allows the use of the Web for the traditional function of a manufacturers representative (or other form of independent salesman) thus allowing small companies to have an active sales presence. It will be appreciated that, while the example provided uses the categories of buyers, sellers and agents, it is not restricted to them in any way, and could include users who can link their services to the transactions, such as banks and other providers of payment methods, shippers, and perhaps even legal review.

These examples are but a few of the many ways that the invention could be employed in e-commerce and other network applications and should not be construed as in any way limiting the scope of the invention.

We claim:

1. A computer network based transactional method which executes on a computer system and network including processor means, data storage means, registers, register formation means, display means, input means, communication means, and communication mediation means, said computer network based transactional method comprising the steps of:
prompting on said display means for user entry by said input means the nature of such transaction in which said user wishes to participate;
searching said data storage means for registers containing transactional requirements of other system users who may wish to participate in a transaction of the nature specified;
informing such users as to the existence on the system of other users who are potential participants in the specified transaction;
allowing communications between said users by means of a dedicated communications system containing said communications mediation means;
presenting said communication mediation means to users by said display means which contain said input means which define the hierarchical stages of the transaction;
informing such users as complete all the hierarchical stages of said transactions that said transaction is complete.

2. The method of claim one wherein one or more of the users does not have a presence on the web.

3. The method of claim 1 wherein one element of the communication means is telephonic.

4. The method of claim 1 wherein input means and registry means allows users to enter an evaluation of participants in their transaction in such a manner that said evaluation is available to other users.

5. The method of claim 1 wherein a first user may select a means of controlling, modifying or restricting said communications mediation means by which other users interact with said first user.

6. The method of claim 1 wherein a first user may select a means of controlling, modifying or restricting said communications mediation means by which other users interact with said first user wherein such control modification or restriction is selected by the input means displayed on the display means.

7. The method of claim 1 wherein one of the registries contains a record of all the communications between users of the system who have completed or partially completed a transaction wherein said register is available to all the users who are participating in the transaction

8. The method of claim 1 wherein each transaction is given a unique identifying means that may be accessed by the users who are participating in the transaction.
